(19) United States
(12) Patent Application Publication
(10) Pub. No.: US 2009/0240862 A1
(43) Pub. Date: Sep. 24, 2009

(54) System Design for a Digital Electronic Sign Board

(75) Inventors: Hung-Pin Chen, Hsinchu (TW); Shen-Hsiung Chou, Hsinchu (TW); Jing-Lin Zhang, Hsinchu (TW); Hung-Yen Chiu, Hsinchu (TW); Ding-Hua Ting, Hsinchu (TW); Tsan-Chung Lee, Hsinchu (TW); Kuo-Tsung Sun, Hsinchu (TW)

Correspondence Address: SCHMEISER OLSEN & WATTS, 18 E UNIVERSITY DRIVE, SUITE # 101, MESA, AZ, 85201, US

(73) Assignee: WINCOMM CORPORATION, Hsinchu (TW)

(21) Appl. No.: 12/051,167

(22) Filed: Mar. 19, 2008

(51) Int. Cl. G06F 13/00

(52) U.S. Cl. 710/301

(57) ABSTRACT

A system design for a digital electronic sign board comprises a main circuit module, an adapter module and a computer module; wherein the adapter module is fixed between the main circuit module and the computer module. The main circuit module and the adapter module are fixed in the digital electronic sign board. The computer module is externally inserted into the digital electronic sign board. Therefore the computer module and the main circuit module are electrically connected through the adapter module. The system design of the present invention removable and attached the computer module with the main circuit module. As a result, when a maintenance worker needs to perform maintenance on the computer module, he or she can conveniently pull out the computer module from the digital electronic sign board and insert the computer module back to the digital electronic sign board after maintenance is done so as to improve the efficiency and quality of maintenance.

### BACKGROUND OF THE INVENTION

1. Field of the Invention

The present invention relates to a system design for a digital electronic sign board, and more particularly, to a system design in which a computer module is removable and attached to a main circuit board so as to pull out and insert the computer module from or into the digital electronic sign board.

2. Description of the Prior Art

Nowadays there are various digital electronic sign boards installed in public areas for providing information or posting advertisements; however, when a content provider wants to change or add information contents, it is necessary to attach a computer externally to update the displaying contents or advertisements. Although the above mentioned technique can satisfy the purpose of displaying information or advertisements, there are a few issues presented in its usage:
1. When a computer equipped on the digital electronic sign board needs maintenance or information update, it is necessary to disassemble the whole digital electronic sign board to retrieve the computer for maintenance or information update. It often takes a long time and lot of efforts for the maintenance; therefore it is inconvenient and laborious for maintenance workers;
2. When the computer is attached to the back side of the digital electronic sign board, it would increase the whole volume and make it difficult to install the digital electronic sign board;
3. There is a certain limitation to the volume of the computer when it is to be attached to the digital electronic sign board, making it inconvenient for computer upgrades.

Therefore, the traditional system design for a electronic sign board presents several shortcomings to be overcome.

In view of the above-described deficiencies of the traditional system design for a electronic sign board, after years of constant efforts in research, the inventor of this invention has consequently developed and proposed a new system design for a digital electronic sign board in the present invention.

### SUMMARY OF THE INVENTION

It is an object of the present invention to provide a system design for a digital electronic sign board in which a computer module is removable and attached to a main circuit board. As a result, when a maintenance worker needs to perform maintenance on the computer module, he or she can conveniently pull out the computer module from the digital electronic sign board and insert the computer module back to the digital electronic sign board after maintenance is done so as to improve the efficiency and quality of maintenance.

It is another object of the present invention to provide a system design for a digital electronic sign board in which the computer module is removable and attached to the main circuit board; therefore the computer module can be conveniently disposed with a slot for inserting a graphics card, a video card, or a DIV output card to enhance versatile capabilities.

It is another object of the present invention to provide a system design for a digital electronic sign board, the system design can improve the efficiency and quality of maintenance, reduce manufacturing costs, simplify the system complexity, facilitate system upgrade and also provide small volume with wide application range.

The present invention discloses a system design for a digital electronic sign board comprising a main circuit module, an adapter module and a computer module; wherein the adapter module is disposed between the main circuit module and the computer module. The main circuit module and the adapter module are fixed in the digital electronic sign board. The computer module is externally inserted into the digital electronic sign board; therefore the computer module and the main circuit module are electrically connected through the adapter module.

These features and advantages of the present invention will be fully understood and appreciated from the following detailed description of the accompanying Drawings.

### BRIEF DESCRIPTION OF THE DRAWINGS

FIG. 1 illustrates an implementation view of a system design for a digital electronic sign board in the present invention; and

FIG. 2 illustrates another implementation view of a system design for a digital electronic sign board in the present invention.

### DETAILED DESCRIPTION OF THE PREFERRED EMBODIMENT

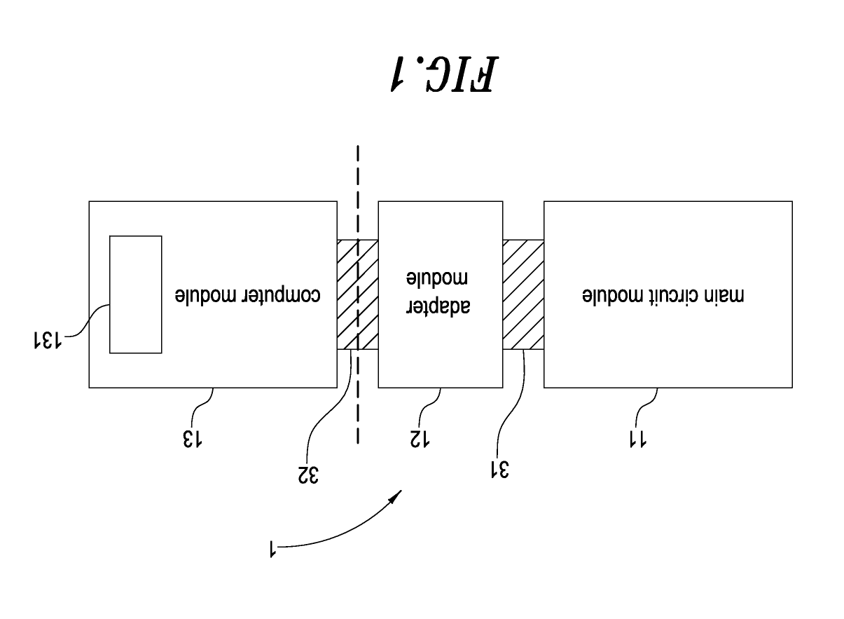

Please refer to FIG. 1, which illustrates an implementation view of a system design for a digital electronic sign board in the present invention, the system structure for a digital electronic sign board 1 comprises:

a main circuit module 11, which is fixed in the digital electronic sign board and couples to an adapter module 12 through a first connector 31;

an adapter module 12, which is fixed in the digital electronic sign board and comprises the first end coupled with the main circuit module 11 through the first connector 31, the second end disposed with a second connector 32 and coupled with a computer module 13 through the second connector 32;

the computer module 13, which couples with the adapter module 12 through the second connector 32 and comprises a slot 131 disposed thereon; wherein the slot 131 is for inserting a graphics card, a video card, or a DIV output card.

The present invention disposes the adapter module 12 between the main circuit module 11 and the computer module 13. The main circuit module 11 and the adapter module 12 are fixed in the digital electronic sign board. The computer module 13 is externally inserted into the digital electronic sign board and couples with the adapter module 12 through the second connector 32. Therefore the computer module 13 and the main circuit module 11 are electrically coupled through the adapter module 12.

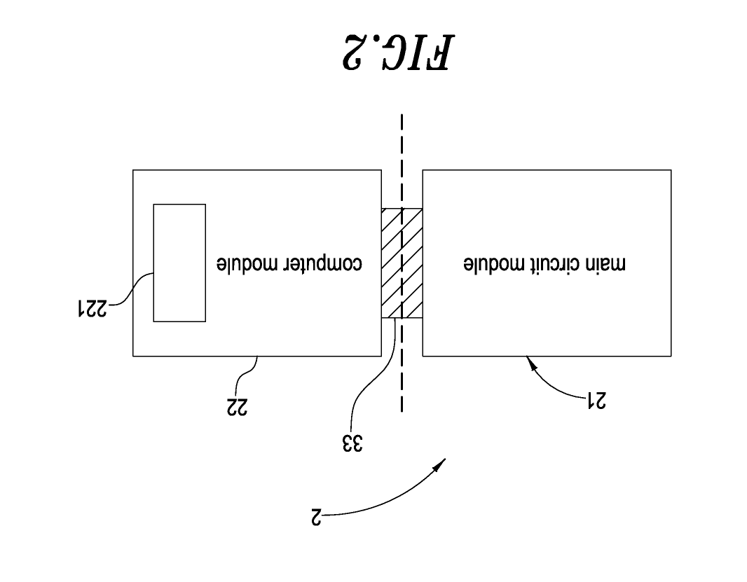

Please refer to FIG. 2, which illustrates another implementation view of a system design for a digital electronic sign board in the present invention, the system structure for a digital electronic sign board 2 comprises:

the main circuit module 21, which is fixed in the digital electronic sign board and couples with the computer module 22 through a connector 33;

the computer module 22, which couples with the main circuit module 21 through the connector 33 and comprises a slot 221 disposed thereon; wherein the slot 221 is for inserting a graphics card, a video card, or a DIV output card.

The present invention fixes the main circuit module 21 in the digital electronic sign board, the computer module 22 is externally inserted to the digital electronic sign board and electrically couples with the main circuit module 21 through the connector 33.

The present invention provides a system design for a digital electronic sign board, which when compared with traditional system designs, is advantageous because:

1. The present invention provides a system design for a digital electronic sign board in which a computer module is removable and attached to a main circuit board, so when a maintenance work needs to perform maintenance on the computer module, he or she can conveniently pull out the computer module from the digital electronic sign board and insert the computer module back to the digital electronic sign board after maintenance is done so as to improve the efficiency and quality of maintenance.

2. The present invention provides a system design for a digital electronic sign board in which the computer module is removable and attached to the main circuit board; therefore the computer module can be conveniently disposed with a slot for inserting a graphics card, a video card, or a DIV output card to enhance versatile capabilities.

3. It is another object of the present invention to provide a system design for a digital electronic sign board, the system design can improve the efficiency and quality of maintenance, reduce manufacturing costs, simplify the system complexity, facilitate system upgrade and provide small volume with wide application range.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A system design for a digital electronic sign board, comprising:
a main circuit module being fixed in the digital electronic sign board and coupling to an adapter module through a first connector;
the adapter module being fixed in the digital electronic sign board and having a first end coupled with the main circuit module through the first connector, the adapter module having a second end disposed with a second connector and coupled with a computer module through the second connector;
the computer module coupling with the adapter module through the second connector and having a slot disposed thereon;
wherein the present invention disposes the adapter module between the main circuit module and the computer module, the main circuit module and the adapter module are fixed in the digital electronic sign board, the computer module is externally inserted into the digital electronic sign board and couples with the adapter module through the second connector, therefore the computer module and the main circuit module are electrically coupled through the adapter module.

2. The system design for a digital electronic sign board as claimed in claim 1, wherein the slot is for selectively inserting a graphics card, a video card, or a DIV output card.

3. A system design for a digital electronic sign board, comprising:
a main circuit module being fixed in the digital electronic sign board and coupling with a computer module through a connector;
a computer module coupling with the main circuit module through the connector and having a slot disposed thereon;
wherein the present invention fixes the main circuit module in the digital electronic sign board, the computer module is externally inserted to the digital electronic sign board and electrically couples with the main circuit module through the connector.

4. The system design for a digital electronic sign board as claimed in claim 3, wherein the slot is for selectively inserting a graphics card, a video card, or a DIV output card.
